(19) United States
(12) Patent Application Publication
(10) Pub. No.: US 2006/0074360 A1
(43) Pub. Date: Apr. 6, 2006

(54) Holding device for massager

(76) Inventor: Chong-Fa Yu, Panchiao City (TW)

Correspondence Address: BIRCH STEWART KOLASCH & BIRCH, PO BOX 747, FALLS CHURCH, VA, 22040-0747, US

(21) Appl. No.: 10/954,264

(22) Filed: Oct. 1, 2004

(51) Int. Cl. A61H 23/00

(52) U.S. Cl. 601/107; 601/72; 601/80

(57) ABSTRACT

A massager includes a massager body having a bottom on which massaging elements are mounted. A primary holding structure comprised of a saucer-like member is connected to a top of the massager body by a neck for being held by a single hand. Two handgrips extend in opposite directions from opposite sides of the massager body for being held by two hands of a user, respectively. Each handgrip forms a recess in bottom side thereof for accommodating fingers of the hand holding the handgrip. The massager further includes a support stand positionable on a fixture surface and forms, in a top thereof, a cavity for receiving and retaining the massager body therein in an up-side-down manner to expose the massaging elements on the top side of the stand whereby the massage serves a sole massaging device.

### BACKGROUND OF THE INVENTION

1. Field of the Invention

The present invention relates generally to a massaging device, and in particular to a massager comprising a holding device that allows a user to stably and firmly holding the massager without great effort in doing massaging and can also be converted into a sole massaging device.

2. The Related Art

Most of the modern people, especially urban residents, are too busy in working and social activities to take necessary physical exercise. Due to lack of proper exercise, the urban people are susceptible of physical weakness, such as pain and soreness of muscles. One of the commonly seen solutions for such a problem of soreness of muscles is massage, which is performed by applying forces on different portions of a person's body to relax the sore muscles, usually by bare hands of a massage master. Alternatively, a massaging device or a massager is employed by the user to do massage for oneself.

FIG. 1 of the attached drawings shows a conventional massaging device, which comprises an elongated body 11 having a head portion on which massaging elements 12 are mounted for contacting and performing massage on a user's body and an opposite tail portion forming a handle 13 for hand holding by the user. To do massage, the user holds the handle 13 by one of his or her hands and positions the massaging elements 12 on the portion of his or her body where massage is to be performed. By properly applying a torque to the massager body 11 with the hand holding the handle 13, a contact force is induced between the massaging elements 12 and the user's body. Such a torque is often provided by the user's index finger extending along and overlapping the handle 13. However, since the index finger is much shorter than the overall length of the elongated body 11 of the massager, a great effort is required for the user to apply proper massaging force to his or her body. Thus, such a conventional device is inefficient in applying massaging force to the user's body.

### SUMMARY OF THE INVENTION

An objective of the present invention is to provide a massager having a holding device that allows a user to effortlessly hold and use the massager in obtaining satisfactory massage effect.

Another objective of the present invention is to provide a massager having a holding device that allows a user to directly apply a contact force between the massager and the user's body to enhance efficiency and effectiveness of massage.

A further objective of the present invention is to provide a holding device for a massager, which allows a user to selectively hold the massager with one single hand or two hands.

Yet a further objective of the present invention is to provide a massager that can be accommodated in a support stand positioned on a fixture surface to serve as a stationary massager for user's soles.

In accordance with the present invention, to realize the above objectives, a massager comprises a massager body having a bottom on which massaging elements are mounted. A primary holding structure comprised of a saucer-like member is connected to a top of the massager body by a neck for being held by a single hand. Two handgrips extend in opposite directions from opposite sides of the massager body for being held by two hands of a user, respectively. Each handgrip forms a recess in bottom side thereof for accommodating fingers of the hand holding the handgrip. The massager further comprises a support stand positionable on a fixture surface and forms, in a top thereof, a cavity for receiving and retaining the massager body therein in an up-side-down manner to expose the massaging elements on the top side of the stand whereby the massage serves a sole massaging device.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a perspective view of a conventional massager;

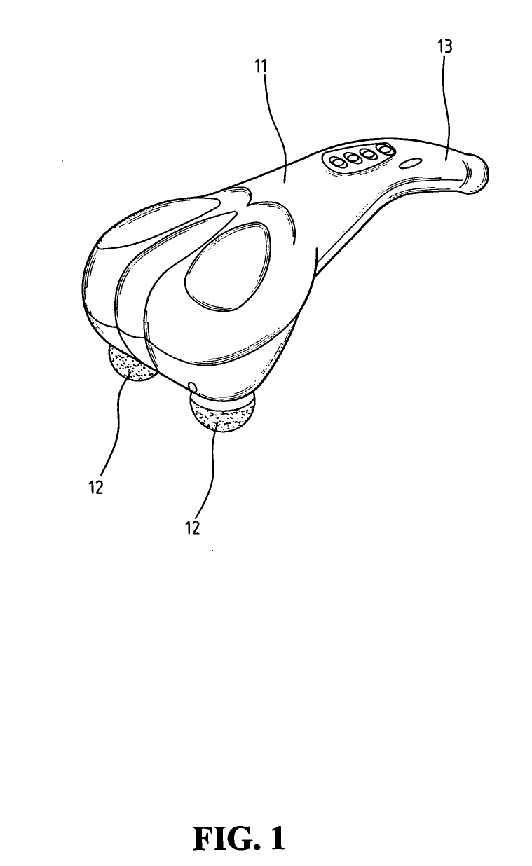

FIG. 2 is a perspective view of a massager constructed in accordance with the present invention;

FIG. 3 is a top plan view of the massager of the present invention;

FIG. 4 is a bottom view of the massager of the present invention;

FIG. 5 is a schematic view illustrating the operation of the massager of the present invention with one single hand;

FIG. 6 is a schematic view illustrating the operation of the massager of the present invention with two hands; and

FIG. 7 is a perspective view showing the massager of the present invention accommodated in a support stand to serve as a stationary massager for user's soles.

### DETAILED DESCRIPTION OF THE PREFERRED EMBODIMENT

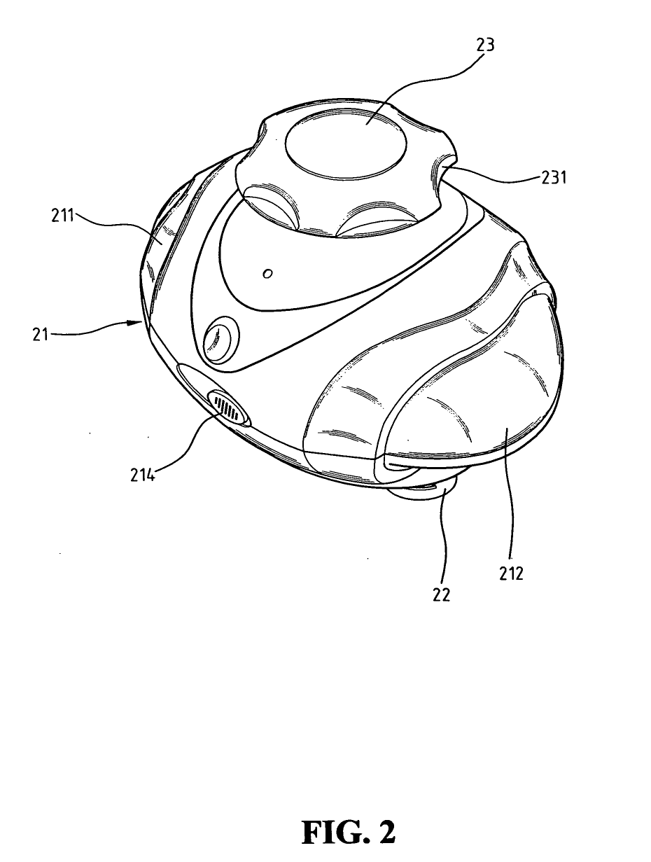

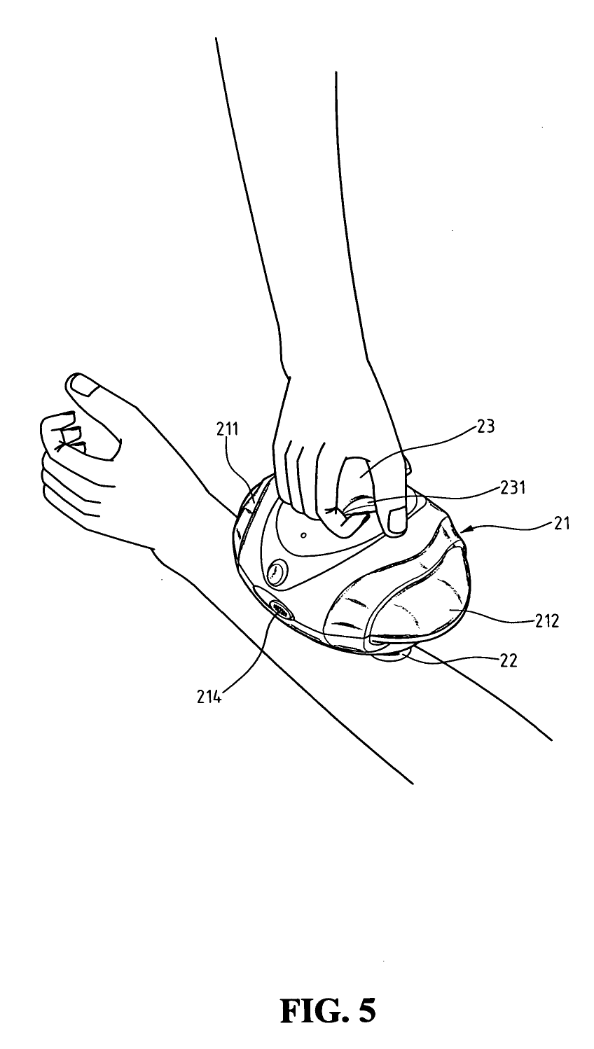

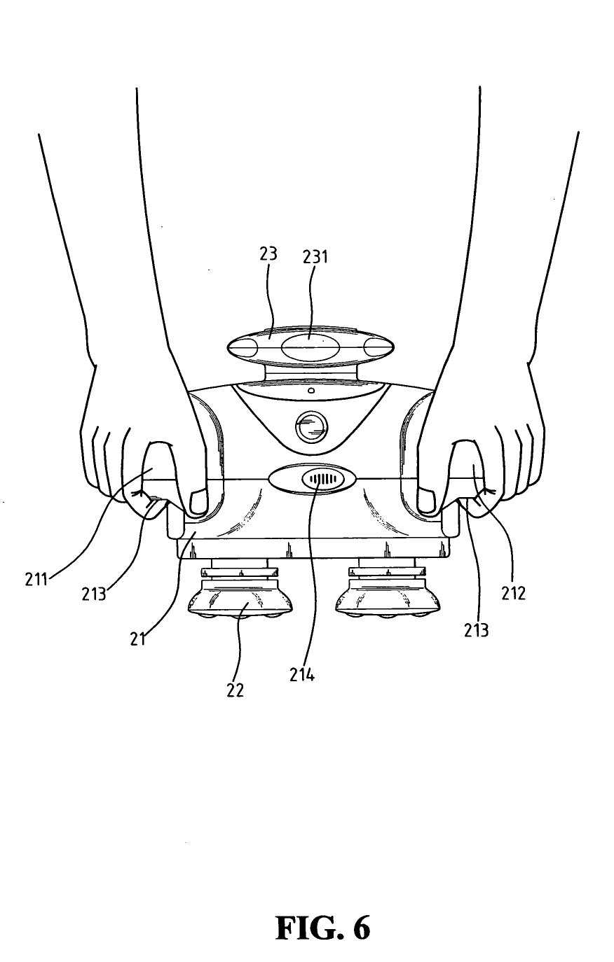

Referring to the drawings and in particular to FIG. 2, a massager constructed in accordance with the present invention comprises a body 21 having a bottom (not labeled) on which a plurality of massaging elements 22 are mounted and means for user's hand holding the massager body 21 to perform massaging operation on the user's body, as illustrated in FIGS. 5 and 6. A control 214 is provided at a proper location on the massager body 21, such as at a front face of the massager body, as illustrated in the drawings. The control 214 serves as for example a switch for turning on/off the massaging elements 22.

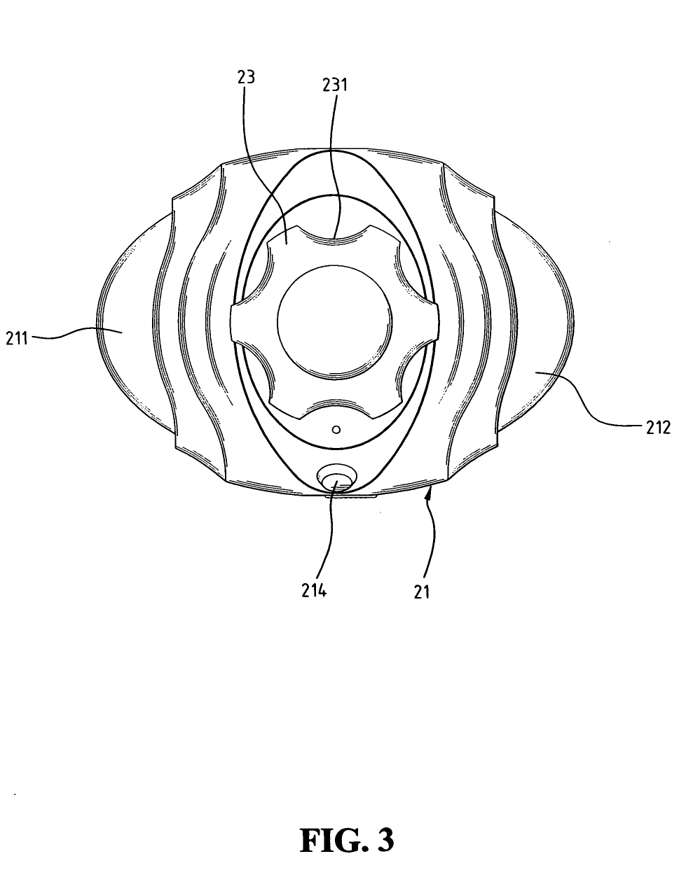

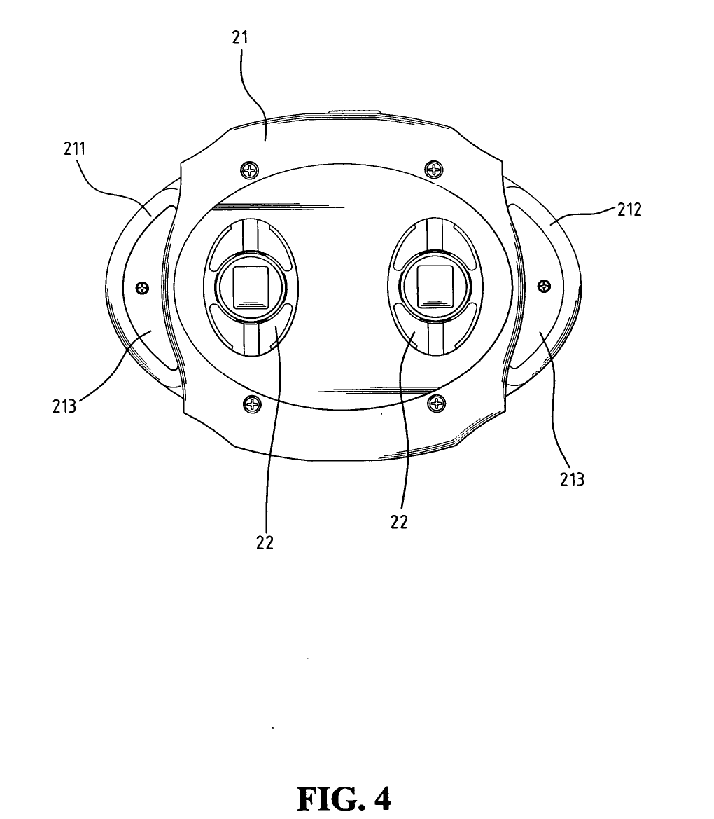

Also referring to FIGS. 3 and 4, in the embodiment illustrated, two massaging elements 22 are mounted on the bottom of the massager body 21 for direct contact with the portion of the user's body where the massage operation is to be performed. The massaging elements 22 can be constructed to vibrate or perform reciprocal movement, which induces a massaging force on the muscles of the user. To perform massaging operation on different portions of the user's body, the massaging elements 22 may be of different shapes, such as pillar or round-ended. If desired, interchangeable massaging elements 22 can be employed.

On the top of the massager body 21 that is opposite to the massaging elements 22, a primary holding structure 23 that constitute in part the holding means of the massager is formed. The primary holding structure 23 comprises a saucer-like configuration, preferably a circular saucer, having a size that can be firmly held by the user's palm. To accommodate the user's fingers, recesses 231, preferably having a concave arcuate shape, are formed and spaced along an outer circumference of the saucer-like primary holding structure 23. As best seen in FIG. 6, the primary holding structure 23 is connected to the top side of the massager body 21 by a neck (not labeled) whereby a space is formed between the outer circumference of the saucer-like configuration and the top of the massager body 21 to accommodate finger tips when the user's palm grasps the primary holding structure 23, as shown in FIG. 5.

The provision of the recesses 231 allows the user to firmly hold the primary holding structure 23. The primary holding structure 23 is preferably located at a center portion of the top of the massage body 21, as best seen in FIG. 3, which allows the user to directly apply a force to the massaging elements 22.

FIG. 5 shows the operation of the massager that is held by one single hand. The user may hold the massager by using one hand to grasp the primary holding device 23 with fingers accommodated in the recesses 231. By simply positioning the massager on the portion of his or her body, due to the fact that the massaging elements 22 are located opposite to the primary holding device 23, the massaging elements 22 can get direct contact with the user's body and a massaging force can be directly applied to the user's body.

The holding means of the massager also comprises a secondary holding device, including two handgrips 211, 212 extending in opposite directions from opposite lateral sides of the massage body 21. Each handgrip 211, 212 is sized to be firmly held by one hand whereby the user may stably and firmly hold the massager by using both hands to respectively grasp the handgrips 211, 212, as illustrated in FIG. 6. Each handgrip 211, 212 has a bottom face in which a recess 213 is formed for accommodating the fingertips of the hand holding the handgrip 211, 212. Such recesses 213 can be blind holes, as illustrated in the drawings, or alternatively, the recesses 213 can be replaced by through holes.

The secondary holding device allows the user to hold the massager with both hands and a great massaging force can thus applied to another person's body on which massage is to be performed. This provides a stronger massage effect, as compared to the embodiment of using one single hand to hold the massager.

FIG. 6 shows the operation of the massager that is held by both hands grasping the handgrips 211, 212. The operator of the massager can then position the massaging elements 22 of the massager on the portion of another person's body, such as back, on which massage is to be performed. The handgrips 211, 212 on opposite sides of the massage body 21 allow the user or operator to very stably and firmly hold the massager and a great massaging force can be applied. Alternatively, the operator may use two hands to grasp the primary holding device 23 and one of the handgrips 211, 212, respectively.

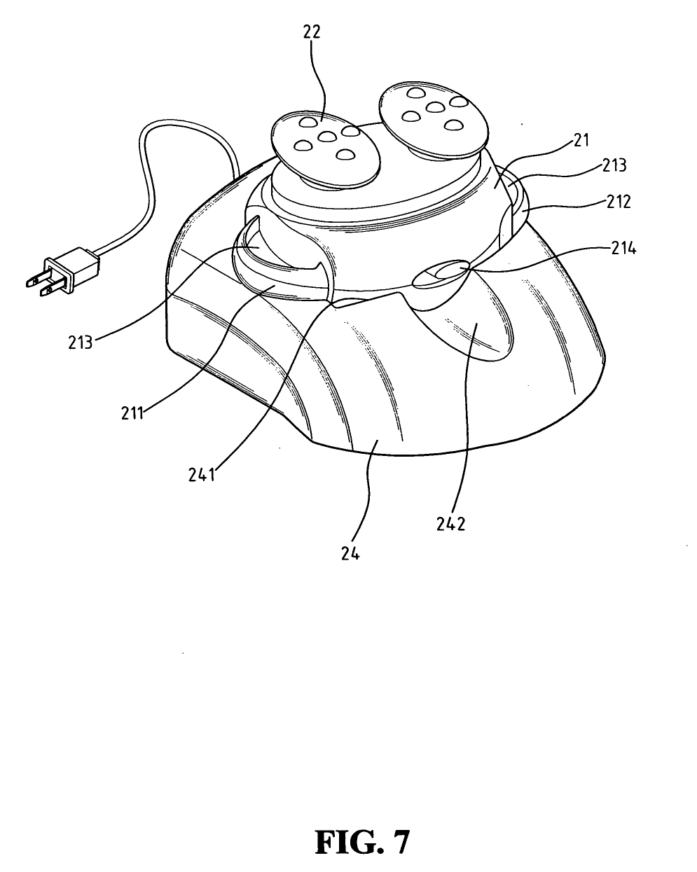

Also referring to FIG. 7, the holding means of the massager may further comprises an additional support stand 24, which is positionable on a fixture surface to support the massager as a stand-alone stationary massaging device for treating for example the user's soles. The support stand 24 forms a cavity 241 on topside thereof The cavity 241 is sized and configured to substantially snugly receive and retain the massager body 21 therein in an up-side-down manner. In this way, the massaging elements 22 of the massager are exposed on the topside of the support stand 24. The user, who may sit down on a chair of proper height, can place his or her soles on the massaging elements 22 for massaging the soles.

Preferably, a notch 242 is defined at an edge of the cavity 241 for accomodating the control 214 of the massager. The operator or user may extend his or her finger into the notch 242 for operating the control 214.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A massager comprising:
a massager body having a bottom on which at least one massaging element is mounted;
a primary holding structure mounted to a top of the massager body adapted to be held by a single hand; and
two handgrips extending in opposite directions from opposite sides of the massager body, each adapted to be held by one hand, a recess being defined in bottom of each handgrip for accommodating fingers of the hand holding the handgrip.

2. The massager as claimed in claim 1, wherein the recess is formed by a blind hole defined in bottom of the handgrip.

3. The massager as claimed in claim 1, wherein the primary holding structure comprises a saucer-like member connected to the top of the massager body by a neck whereby a space is formed between the saucer-like member and the top of the massager.

4. The massager as claimed in claim 3, wherein recesses are defined in and spaced along an outer circumference of the saucer-like member for accommodating fingers of the single hand holding the primary holding structure.

5. The massager as claimed in claim 1 further comprising a support stand positionable on a fixture surface, the support stand having a top defining a cavity sized and configured to substantially snugly receive and retain the massager body therein in an upside-down manner to expose the massaging element on topside of the support stand.

6. The massager as claimed in claim 5, wherein the massager body has a control for turning on/off the massaging element, the support stand forming a notch in an edge of the cavity for accommodating the control.
